(19) United States
(12) Patent Application Publication
(10) Pub. No.: US 2023/0381905 A1
(43) Pub. Date: Nov. 30, 2023

(54) METHOD FOR THE COMPUTER-AIDED OPTIMIZATION OF TOOL TRANSPORTATION OPERATIONS FOR AT LEAST ONE TOOL MAGAZINE HAVING A NUMBER OF MAGAZINE SPACES

(71) Applicant: Siemens Aktiengesellschaft, München (DE)

(72) Inventors: Georg Baier, München (DE); Lena Hupp, München (DE); Christian Royer, Ottobrunn (DE)

(21) Appl. No.: 18/034,198

(22) PCT Filed: Nov. 4, 2020
(86) PCT No.: PCT/EP2020/080981

§ 371 Date: Apr. 27, 2023

(51) Int. Cl. B23Q 3/155; G05B 19/4093

(52) U.S. Cl. CPC B23Q 3/15503; G05B 19/40938; G05B 2219/36361; G05B 2219/36362

(57) ABSTRACT

Provided is a method and a device for the computer-aided optimization of tool transportation operations for at least one tool magazine that has a number of magazine spaces and is used or is able to be used for a machine tool that is used to produce one or more workpieces with the aid of the tools provided at a provision space by a magazine device. The input comprises the set of tools and the space requirement of each tool and a permissible starting magazine occupancy. In step 1, a set of available time intervals is determined. In step 2, one or more tool transportation operations are assigned to a respective time interval under the condition that the movement period for the tool transportation operation is less than or equal to the length of the time interval. In step 3, one or more tool transportation operations are performed.

### CROSS-REFERENCE TO RELATED APPLICATIONS

This application claims priority to PCT Application No. PCT/EP2020/080981, having a filing date of Nov. 4, 2020, the entire contents of which are hereby incorporated by reference.

### FIELD OF TECHNOLOGY

The following relates to a method and to a device for the computer-aided optimization of tool transports for at least one tool magazine having a number of magazine locations, which is used or is usable for a machine tool that is employed for the manufacture of one or more workpieces with the aid of the tools provided by a magazine apparatus to a provision location.

### BACKGROUND

Modern machine tools allow rapidly changing production of different workpieces at a time very close to the requirement of the customer. In order to allow continuous production despite a wide variety of workpieces, these machine tools have large magazines in which the tools are deposited.

When exchanging the tool, the transport of the tools from the magazine to the spindle and back may lead to waiting times. In order to avoid such waiting times, the magazine occupancy is adapted. A magazine occupancy that minimizes waiting time is however dependent on the program of the machine tool, that is to say the sequence of use and the duration of use of the tools used. If the program changes, for example because a different product is intended to be produced, the magazine occupancy needs to be adapted.

According to DIN 69 651, a machine tool is a “mechanized and more or less automated manufacturing instrument which generates a predetermined shape on the workpiece or a variation of a predetermined shape on a workpiece by relative movement between the workpiece and the tool” [6]. Machine tools on which the present context is based are NC lathes. These have a tool spindle in which the processing tool, also referred to as the spindle tool, is located during the processing. The tools which may be used by the machine in order to process a workpiece are deposited in a tool magazine. There are different types of tool magazines, such as chain or shelf magazines. Very many different tools may be accommodated in these magazines: up to 500 tools or more.

In the present context, shelf magazines will be considered. The tools are deposited therein at fixed locations, from/at which they are picked up/deposited by a device (magazine operating apparatus). In contrast to the chain magazine, the access time to a tool is in this case independent of the current configuration of the magazine. This type of magazine is therefore advantageous when a wide variety of different workpieces is intended to be produced with a machine, for which a multiplicity of different tools are needed.

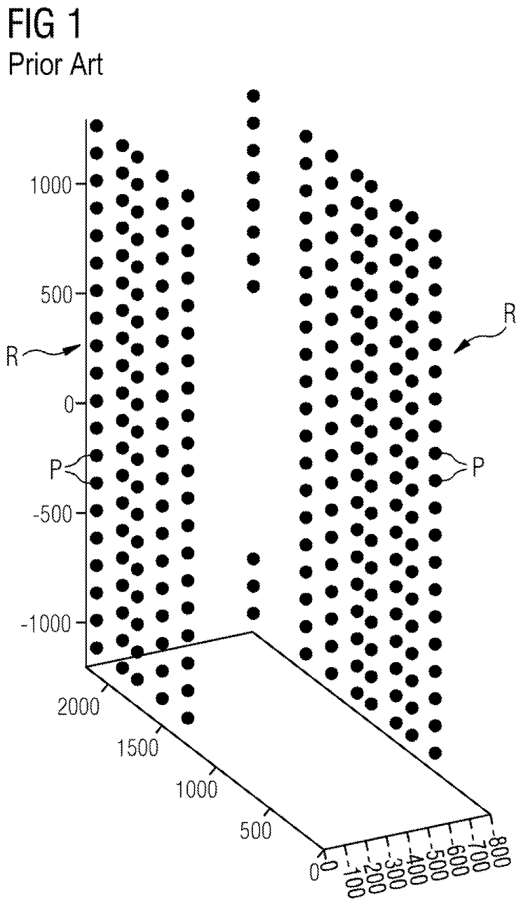

PCT/EP2018/074999 has already proposed re-sorting of tools in the magazine, for which the re-sorting of the tools requires production to be suspended. In FIG. 1, which is taken from the aforementioned patent application, a shelf magazine R having magazine locations or magazine positions P is shown. A fictitious number of magazine positions is indicated on the x, y and z axes.

The processing of a workpiece is carried out with a predetermined sequence of tools. One tool may quite possibly occur several times in this sequence. During the processing of a workpiece with a tool of the sequence, the spindle tool, the previous tool is returned to its location in the shelf magazine and deposited there. An empty trip is then made to the site of the following tool. The latter is then taken and transported to the handover point or providing location to the spindle. Once the processing with the current spindle tool is completed, the tool in the spindle is exchanged (for example with a tool changer). If the processing with the spindle tool is completed but the following tool is not yet ready, there is a waiting time in the spindle supply and the production duration of the workpiece is increased.

The efficiency of a machine tool may be influenced by various factors. Yet if the NC programs and the sets of the workpieces to be processed are fixed, the machine efficiency is then influenced only by waiting times between the successive steps of processing the workpiece (operations). These waiting times occur when there is a waiting time at the end of the processing with the spindle tool because the next tool is not yet ready at the handover point of the spindle. The tools are therefore allocated magazine locations that lead to a minimization of these waiting times.

Besides their actual tool property, tools have other characteristics or properties. They differ, for example, in size and weight. Shelf magazines therefore have different types of magazine locations in order to accommodate the corresponding tools. If tools are oversize, one or possibly even more neighboring magazine locations need to be kept free. Furthermore, certain locations may be blocked in shelf magazines because of defects or design features. A magazine location is occupiable when it is free (not occupied by any tool) or becomes free, that is to say a tool at this magazine location is first brought to another magazine location so that this magazine location has become free or becomes free for the tool following next. An allowed magazine occupancy is an arrangement of the tools in the magazine such that each tool is located at an occupiable magazine location and the location requirements of the neighboring tools do not overlap.

Allowed magazine locations depend on the current occupancy of the tool magazine.

Accordingly, all allowed magazine locations, also referred to below as magazine positions, are subject to additional restrictions:
at most one tool may be placed at each magazine location.
The location requirement of the tool must not overlap with the location requirement of another tool, generally a neighboring tool, in the magazine or protrude beyond the edge of the shelf magazine.

A magazine occupancy with minimal waiting times depends on the workpieces to be produced and the associated NC programs. If the production changes, this necessitates adaptation of the magazine occupancy.

Re-sorting of tools in the magazine, for which the re-sorting requires production to be suspended, has already been proposed in [3]. FIG. 1 of the aforementioned patent application also shows a shelf magazine.

Once a new magazine occupancy and a technically feasible tool relocation or transport sequence are given, this new magazine occupancy may be configured after the conclusion of the ongoing program and before the start of the subsequent program. That is to say, the production stops until the re-sorting is completed. The efficiency of the machine tool is thereby reduced. Under certain preconditions, the re-sorting of the magazine may be carried out during the execution of the current program, without generating additional waiting times.

It is assumed that the time for changing a tool in the machine tool is quite long in comparison of the time for processing with a tool. Otherwise, no waiting times occur in the spindle supply and the magazine occupancy has no effect on the efficiency of the machine tool. It is furthermore assumed that the processing times of the individual program steps have different lengths, so that waiting times also occur in the magazine operating apparatus.

### SUMMARY

An aspect relates to a method and a device which make it possible to integrate the tool relocation into the waiting times of the magazine operating apparatus.

Embodiments of the invention claim a method for the computer-aided optimization of tool transports for at least one tool magazine having a number of magazine locations, which is used or is usable for a machine tool that is employed for the processing of one or more workpieces with the aid of the tools provided by a magazine apparatus at a provision location, having the following steps:
a) recording a set of tools,
b) recording the location requirement for each tool,
c) recording a set of occupiable magazine locations for each tool, at least one subset thereof comprising allowed magazine locations which are dependent on the respective location requirement of the tools, in particular of the tools respectively neighboring one another,
d) recording a set of movement time durations which respectively comprises a trip of the magazine operating apparatus from one magazine location to another magazine location or from a magazine location to the provision location or from the provision location to a magazine location,
e) recording an allowed initial magazine occupancy, an initial magazine location for each tool being recorded,
f) recording a set of tool transports from one magazine position to another allowed magazine position, a tool transport from this set requiring a movement time duration,
g) determining a set of at least one available time interval, in which the movement time duration of one or more tool transports is respectively equal at most to the processing time duration in which the tool provided at the provision location is used for the processing of a workpiece,
h) allocating at least one tool transport from the set off) to a time interval from the set of g) under the condition that the movement time duration for the tool transport is less than or equal to the length of the time interval,
i) carrying out the at least one tool transport while the machine tool for the processing of a workpiece is in operation in a ready state or in a processing state, as soon as the machine tool reaches an operating state which has (already) been assigned or is (currently being) assigned to one of the time intervals determined in g) and allocated in h).

A single or multiple repetition of step i) is possible.

A partial order of the set of tool transports (see f)) may be specified such that a tool transport that has not yet been performed may be performed when all tool transports previously arranged in the partial order have been performed. The partial order may influence the allocation of at least one tool transport to a time interval according to h). The chronological succession of the allocated time intervals should be consistent with the partial order of the tool transport.

The partial order gives a priority of a first tool, which initially has to be brought before a second tool to a different magazine location which is free or becoming free before the second tool can be brought to its magazine location. In order to avoid unresolvable cycles or possible deadlocks in the tool transport sequences, deadlocks may for example be resolved by the procedure from the patent application PCT/EP2018/074999 mentioned in the introduction.

The aforementioned allocation of the one or more tool transports or relocations to a time interval may be carried out by mixed-integer linear optimization, these respectively being explained in more detail in the exemplary embodiments below. If the set of tool transports is partially ordered, the partial order is taken into account in the mixed-integer linear optimization.

Linear optimization is a special case of optimization methods. It deals with the optimization of linear objective functions over a set, which is restricted by linear equations and inequalities. It is the basis of the solution methods of (mixed) integer linear optimization. A so-called solver is a generic term for special mathematical computer programs that can numerically solve mathematical problems. In connection with MILP (mixed integer linear programming), standard solvers such as for example CPLEX [3], Scip, Gurobi, Xpress may be used for IP programs (integer optimization models). Typically, a start configuration is specified and is led iteratively by optimization to an objective result. A calculation of a nearest neighbor heuristic may be used for a start configuration of the MILP model.

The movement time duration may include both a transport time duration, which comprises a trip of the magazine operating apparatus with a tool, and an empty trip time duration, which means a trip of the magazine operating apparatus without a tool. The transport time duration additionally depends on properties such as for example size, weight of the tool to be transported.

Tool transports may be taken into account with increasing weighting in the increasing time profile when carrying out the at least one tool transport, presupposing that the tool to be transported is unused or is not (any longer) being used or needed for the processing of a workpiece, and/or presupposing that a cumulative waiting time for the magazine operating apparatus in the increasing time profile decreases by a newly allocated magazine location of the tool after the tool transport.

The time intervals in which a plurality of tool transports are possible may be subdivided into further time intervals in which, if possible, only one tool transport is carried out.

A further aspect of embodiments of the invention provides a control instrument which for the computer-aided optimization of tool transports for at least one tool magazine having a number of magazine locations, which is used or is usable for a machine tool that is employed for the processing of one or more workpieces with the aid of the tools provided by a magazine apparatus at a provision location. This control instrument is designed in particular to carry out the method of the type mentioned above and its embodiments. It has at least one processing unit, or processor, which is designed to perform the aforementioned method steps a) to i) and its developments.

The units that are configured to perform such method steps may be implemented as hardware, firmware and/or software.

A further aspect of embodiments of the invention is a computer program product, comprising a computer readable hardware storage device having computer readable program code stored therein, said program code executable by a processor of a computer system to implement a method having program code means for carrying out the method as claimed in one of the preceding method claims when it runs on a control instrument of the type mentioned above or is stored on a computer-readable medium.

The computer program or program product may be stored on a computer-readable medium. The computer program or program product may be written in a conventional programming language (for example C++, Java). The processing instrument may comprise a commercially available computer or server with corresponding input, output and storage means. This processing instrument may be integrated in the control instrument or in the means thereof.

The control instrument and the computer program (product) may be developed or further developed in a similar way to the aforementioned method and its developments.

### BRIEF DESCRIPTION

Some of the embodiments will be described in detail, with reference to the following figures, wherein like designations denote like members, wherein:

FIG. 1 shows by way of example the shelf magazine mentioned in the introduction; and

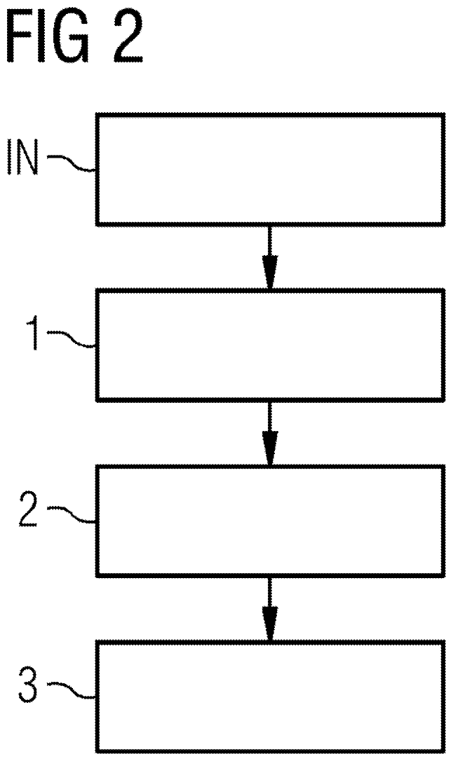

FIG. 2 schematically shows a flowchart of the method according to embodiments of the invention with steps 1 to 4, which are repeatable.

### DETAILED DESCRIPTION

FIG. 1 shows a shelf magazine. A magazine operating apparatus and the tools, as well as the use of a tool for the manufacture of a workpiece, are not represented. A control instrument (not represented), which controls the machine tool (likewise not represented) that uses the shelf magazine, is conceivable. The control instrument is in this case designed in such a way that it can perform the method steps explained in more detail below, or correspondingly controls the machine tool with the magazine apparatus so that it can perform the method steps.

According to FIG. 2, there is the input IN, which comprises the set of tools and the location requirement of each tool as well as an allowed initial magazine occupancy. In step 1, a set of available time intervals is determined. In one time interval, the movement time duration of one or more tool transports is respectively equal at most to the processing time duration in which the tool (spindle tool) provided at the provision location is used for the processing of a workpiece.

In step 2, one or more tool transports are respectively allocated to a time interval under the condition that the movement time duration for the tool transport is less than or equal to the length of the time interval. In step 3, one or more tool transports are carried out. This may be done while the machine tool for the processing of a workpiece is in operation in a ready state or in a processing state.

Furthermore, a set of movement time durations which respectively comprises a trip of the magazine operating apparatus from one magazine location to another magazine location or from a magazine location to the provision location or from the provision location to a magazine location, as well as a set of tool transports from one magazine position, or location, to another allowed magazine position, a tool transport from this set requiring a movement time duration, are recorded as input IN.

The tool transport should transport each tool without collision in respect of its location requirement from its current magazine location to its next magazine location. In this case, it is expedient to establish precedences, or priorities, which require that particular tools be transported before other tools to their next magazine location. The definition of precedences will be explained in more detail below.

A basic heuristic and the steps of the procedure according to embodiments of the invention will first be described in more detail below:

Basic Heuristic

Notation:

To simplify the description of the method, the notation described below is used.

Index sets

| | |
|---|---|
| [symbol] | Set of available time intervals |
| [symbol] | Set of tool relocations |
| [symbol] | Set of allowed magazine positions |
| Parameters | |
| Tᵢ^{s}, Tᵢ^{f} | Start, end time point of interval i ϵ [symbol] |
| Lᵢ^{s}, Lᵢ^{f} | Possible start, end positions of interval i ϵ [symbol] |
| Wᵣ^{t} | Tool of relocation r ϵ [symbol] |
| Wᵣ^{s} | Previous magazine position of tool Wᵣ^{t} for relocation |
| | r ϵ [symbol] |
| Wᵣ^{f} | New magazine position of tool Wᵣ^{t} for relocation r ϵ [symbol] |
| moveTime_{l,l′}^{t} | Trip time for relocation of the tool t from position l to |
| | position l′ |
| moveTime_{l,l′} | Trip time of an idle trip from position l to position l′ |
| loc(t) | Set of all magazine position of tool t during the tool |
| | relocations |
| l⁰ | Position of the location of handover to the spindle |
| ρ | Maximum time of a series of empty and tool relocation trips |
| λ | Parameter, λ ≈ 2, for the definition of λ-lazy operations |

Let t₁ and t₂ be two tools that are exchanged during the operation o at the handover location. The time for returning the tool t₁ to its magazine location, the empty trip of the magazine operating apparatus to the location of the subsequent tool t₂ and the transport of this tool to the handover location is referred to as the cycle time. It is dependent on the magazine locations of the two tools t₁ and t₂ and is generally a few seconds. If the processing time of the operation o is shorter than the maximum cycle time of the magazine operating apparatus, o is referred to as a critical operation. o is called λ-lazy when the processing time of o is more than λ times the maximum cycle time, λ>1. The tool pair (t_{1,} t₂) is similarly referred to as a critical or λ-lazy tuple. For λ=2, the waiting time is for example long enough to carry out an arbitrary tool relocation during the processing of o.

Determination of the available time intervals:

For re-sorting of the tools during production, without the additional occurrence of idle times, waiting times for the magazine operating apparatus are needed. This waiting time, between depositing the last tool and taking up the next tool required is available for further operations of the magazine operating apparatus.

Let λ≈2 and oᵢ, i=1, . . . n, be the set of λ-lazy operations sorted increasingly according to their start time. Let the spindle tools before and after operation oᵢ be tᵢ^{s} and tᵢ^{f}. That is to say, the tools tᵢ^{s} and tᵢ^{f} are exchanged at the handover location during the operation oᵢ. Let the set of available time intervals [symbol] be

[symbol]

={1, . . . ,n} (1)

where the possible start and end positions or instants for time interval i are given by:

$${L}_{i}^{s} = loc ( {t}_{i}^{s} )$$

$${L}_{i}^{f} = loc ( {t}_{i}^{f} )$$

$${T}_{i}^{s} = Starttime of {o}_{i} + max \{ {moveTime}_{{l}^{o} , l}^{{t}_{i}^{s}} \vert l ∈ {L}_{i}^{s} \}$$

$${T}_{i}^{f} = Endtime of {o}_{i} - max \{ {moveTime}_{{l}^{o} , l}^{{t}_{i}^{f}} \vert l ∈ {L}_{i}^{f} \}$$

Sequence of the tool relocations:

Once the current and the desired subsequent allocation of tools to magazine position are given, the sequence in which the tools should be relocated remains to be established. It is assumed that each tool is relocated directly from its current magazine position to the subsequent magazine position. By fixing the initial occupancy and the objective occupancy of the magazine, the following two cases may occur:
1. Some tools must first be transported away from their original magazine location before another tool can be placed thereon.
2. There are cyclic dependencies, that is to say a tool must be transported away from its original magazine location so that it can itself be relocated.

In the first case, precedences between the tool relocations are defined, that is to say the tool relocations are partially ordered. The relocation r′ is less than r, r′ [symbol] r, if r′ must necessarily be relocated before r. If r′ and r are not comparable, that is to say neither r′ [symbol] r nor r [symbol] r′, the relocation of r and r′ may be carried out in both sequences.

In the second case, under some circumstances it is not even possible to achieve the desired allocation just by relocating tools, for example in the case of shelf magazines that have few free locations and tools that require more than one magazine location. If cyclic dependencies occur, they should be removed.

Removal of transport cycles: transport cycles may be removed in various ways. Direct removal is achieved by adapting the objective magazine occupancy. This procedure may be found from the patent application mentioned in the introduction, and also applied in this context. Possible transport cycles may be found efficiently by a depth search in polynomial time. All tools in a cycle are not relocated, but remain at their location. Likewise, all tools that require the relocation of a tool from a cycle beforehand are not relocated and remain at their location. The subsequent allocation of tools to magazine position, which is modified in this way, no longer contains any cyclic dependencies, and the tool relocations are partially ordered.

Alternatively, the restriction that each tool is transported directly from its current magazine position to its final magazine position may be relaxed. A tool may thus be relocated several times, and this additional freedom generally makes it possible to find a cycle-free set of tool relocations. In the corresponding partial order, all tool relocations for one and the same tool are fully ordered. In the case of magazines with very few free locations and many tools that require more than one shelf location, it may nevertheless be necessary for tools to have to be removed from the magazine in order to be able to create the desired subsequent magazine occupancy.

It is assumed below that there is a partially ordered set of tool relocations without cyclic dependencies.

Modeling of the tool relocation:

Let G= [symbol] ∪ [symbol] , E) be a bipartite graph with the node partitions [symbol] and [symbol] and the edge set E. In which case (i, r) is the edge of G if and only if the relocation of tool Wᵣ^{t} is chronologically possible in the time interval i, that is to say tool Wᵣ^{t} is not the spindle tool in the time interval i and the following inequality is satisfied:

$$max \{ {moveTime}_{l , {W}_{r}^{s}} \vert l ∈ {L}_{i}^{s} \} + {moveTime}_{{W}_{r}^{s} , {w}_{r}^{f}}^{{W}_{r}^{t}} + max \{ {moveTime}_{{W}_{r}^{f} , l} \vert l ∈ {L}_{i}^{f} \} \leq {T}_{i}^{f} - {T}_{i}^{s} \qquad ( 2 )$$

The partial order of [symbol] is applied to the edge set E of the graph G. For two edges (i, r), (i′, r′)∈E, the following applies:

(i′, r′) [symbol] (i, r)↔T_{i′}^{f}<Tᵢ^{s}∧r′ [symbol] r (3)

A matching M of the graph G is [symbol] bounded if, for all edges (i, r)∈M, the following applies:

r′ [symbol] r→∃(i′,r′)∈M:(i′,r′) [symbol] (i,r) (4)

Each [symbol] bounded matching M defines a performable sequence of tool relocations [symbol] _{M}={r|(i, r)∈M}. A maximum [symbol] bounded matching therefore corresponds to a maximum performable sequence of tool relocations which may be carried out during the waiting times of the magazine operating apparatus. The maximality applies under the assumptions that only one relocation ever takes place during a waiting time and that the tools exchanged at the provision or handover location during interval i remain at their original locations in the magazine.

Modeling as MIP

The determination of a matching with edge precedences may be modeled as an integer linear program (MIP). On the basis of the notation introduced above, the following variables are defined:

Variables

x_{(i,r)} indicator variable as to whether edge (i,r)∈E is in the matching

A maximum matching with edge precedences is the solution of the integer linear program with the objective function

$$max {\sum }_{( i , r ) ∈ E} {x}_{( i , r )} \qquad ( 5 )$$

while taking into account the following constraints:

$${\sum }_{r ∈ R : ( i , r ) ∈ E} {x}_{( i , r )} \leq 1 , i ∈ 𝒥 \qquad ( 6 )$$

$${\sum }_{i ∈ 𝒥 : ( i , r ) ∈ E} {x}_{( i , r )} \leq 1 , r ∈ R \qquad ( 7 )$$

$${x}_{( i , r )} \leq {{{\sum }_{{i}^{′} ⊂ 𝒥 :}}_{( {i}^{′} , {r}^{′} ) ∈ E}}_{( {i}^{′} , {r}^{′} ) ≺ ( i , r )} {x}_{( {i}^{′} , {r}^{′} )} , ( i , r ) ∈ E , {r}^{′} ≺ r \qquad ( 8 )$$

$${x}_{( i , r )} ∈ \{ 0 , 1 \} , ( i , r ) ∈ E \qquad ( 9 )$$

For an allowed solution x, let Mₓ={(i, r)|x_{(i,r)}=1}⊂E be the set of the edges whose indicator variable x is equal to 1. The inequalities (6) and (7) guarantee that no two edges from Mₓ are allocated to an interval i, or to a tool relocation r, that is to say Mₓ is a matching. The inequalities (8) ensure that the matching Mₓ is [symbol] bounded. [symbol] _{M}_{ₓ} is therefore a performable sequence of tool relocations that is ultimately consistent with the partial order mentioned above. There are commercial and freely available solvers for solving mixed-integer linear programs [2,3]. That is to say, these solvers can calculate a solution for the integer linear program described above for given values of the coefficients and without further intervention of the user. It is therefore possible to calculate maximum sequences of tool relocations that are performed during the waiting times of the magazine operating apparatus.

Extensions to the Heuristic

Taking the program progress into account:

A maximum [symbol] bounded matching corresponds to a performable sequence of tool relocations. The relocations may, however, already begin at the start of the currently running program. The magazine occupancy with minimal waiting times that is determined for this program is therefore altered and waiting times that were originally avoided may occur during production. In order to avoid this undesired effect, the objective function is modified. In other words, the tool transports are taken into account with increasing weighting in the increasing time profile when carrying out the one tool transport, presupposing that the cumulative waiting time for the magazine operating apparatus in the increasing time profile decreases by a newly allocated magazine location of the tool after the tool transport.

Index Sets
T Set of the tools which are contained in a critical tuple
[symbol] (t) Set of the use end instants of tool t in a critical tuple

Let w: [symbol] × [symbol] → [symbol] be a weight function on the edges E of the graph G. Let the values of w be defined as follows:

$$w ( i , r ) = \{ \begin{matrix}- 1 & if {W}_{r}^{t} ∈ T ⋀ {T}_{i}^{f} < max ( t ) \\ 1 & if {W}_{r}^{t} ∈ T ⋀ {T}_{i}^{f} \geq max ( t ) \\ 0 & otherwise\end{matrix} \qquad ( 10 )$$

With the aid of the weight function w, the objective function (5) above of the integer program may be reformulated:

$$max {\sum }_{( i , r ) ∈ E} w ( i , r ) {x}_{( i , r )} \qquad ( 11 )$$

A matching edge (i, r) is therefore included positively in the objective function only if the allocated tool relocation r is concluded after the last use of the tool Wᵣ^{t} in a critical tuple. If, on the other hand, the tool Wᵣ^{t} is still being used after the relocation interval end Tᵢ^{f} in a critical tuple, the matching edge (i, r) contributes negatively to the weight of the matching.

Weighted consideration of the program progress:

The objective function (11) weighted all instants before (after) the last use of a tool from a critical tuple equally. The fact that an individual short waiting time before the end of the program is less relevant is therefore not taken into account.

Let ω(i, r) be an estimate of the additional waiting time in the current program if the tool Wᵣ^{t} is relocated at the time Tᵢ^{s}. Let Ω be a scaling parameter and the weight function \tilde{w}: [symbol] × [symbol] → [symbol] on the edges E of the graph G be defined as follows:

$$\tilde{w} ( i , r ) = 1 - \frac{w ( i , r )}{Ω}$$

If Ω is selected to be approximately of the order of the average waiting time saving per tool from a critical tuple, (i, r) has a negative weight \tilde{w}(i, r) when a relocation of Wᵣ^{t} at the time Tᵢ^{s} requires estimated more additional waiting time during the currently running program than is saved on average per tool by the relocation. The estimates need not be accurate, what is important being only that the relative proportions between different tool relocations r and r′ and the reduction with the program progress match. With a suitable choice of the scaling parameter Ω, the objective function (5) of the integer program from section 4.5 may therefore be replaced with the following objective function (12).

$$max {\sum }_{( i , r ) ∈ E} \tilde{w} ( i , r ) {x}_{( i , r )} \qquad ( 12 )$$

Multiple Intervals:

The modeling above allows at most one tool relocation in the waiting time of the magazine operating apparatus during an operation. If the program contains longer operations and therefore longer waiting times of the magazine operating apparatus, the solutions, with only one relocation, may be very unfavorable. For this case, the modeling may be extended.

For the determination of the time intervals, each λ-lazy operation is allocated an interval. Very long time intervals, which may contain a plurality of tool relocations, are in what follows divided into a plurality of smaller time intervals in which at most only one tool relocation or transport is carried out.

Let ρ be the maximum trip time of an empty trip and a tool relocation trip, that is to say

$$ρ = max \{ {moveTime}_{l , {W}_{r}^{s}} + {moveTime}_{{W}_{r}^{s} , {W}_{r}^{f}}^{{W}_{r}^{t}} \vert r ∈ R , l ∈ \} \qquad ( 13 )$$

A time interval i∈ [symbol] is called a long time interval if the following applies for a k=2,3, . . .

Tᵢ^{f}−Tᵢ^{s}≥kρ+max{moveTime_{l,l′}|l,l′∈ [symbol] } (14)

Let i be a long time interval and k maximum, so that the inequality (14) applies. The interval i is subdivided into k intervals with a length of ρ and ρ+ [symbol] moveTime_{l,l′}. The start time (possible start positions) of the first new interval and the end time (possible end positions) of the last new interval are respectively Tᵢ^{s} (Lᵢ^{s}) and Tᵢ^{f} (Lᵢ^{f}). The intermediate times and intermediate positions are dependent on the choice of the tool relocation that was selected for the preceding time interval. Since the intervals all have at least the length ρ, every series of an empty trip and a tool relocation can be carried out in the interval. In the last time interval, an empty trip to an arbitrary position from Lᵢ^{f} may additionally be carried out. This division is carried out for every long time interval. Let the resulting interval set be [symbol] .

The bipartite graph is extended to [symbol] . Since every tool relocation is possible in the newly generated time intervals, for these intervals i′ all edges (i′, r) for which Wᵣ^{t} is not the spindle tool during the time interval i are introduced into the graph G. For the unchanged time intervals i and tool relocations r, the above criterion (2) continues to be applied. This extended bipartite graph likewise has the property that each [symbol] bounded matching corresponds to a performable sequence of tool relocations.

Although embodiments of the invention have been illustrated and described in detail, embodiments of the invention are not restricted by the examples disclosed and other variations may be derived therefrom by a person skilled in the conventional art, without departing from the scope of protection of embodiments of the invention.

The implementation of the processes or method procedures described above may be performed with the aid of instructions that are present on computer-readable storage media or in volatile computer memories (referred to below summarily as computer-readable memories). Computer-readable memories are for example volatile memories such as caches, buffers or RAM as well as nonvolatile memories such as removable data media, hard drives, etc.

The functions or steps described above may in this case be present in the form of at least one instruction set in/on a computer-readable memory. The functions or steps are in this case not constrained to a particular instruction set or to a particular form of instruction sets or to a particular storage medium or to a particular processor or to particular execution schemes, and may be performed by software, firmware, microcode, hardware, processors, integrated circuits, etc. in standalone operation or in arbitrary combination. A very wide variety of processing strategies may in this case be employed, for example serial processing by a single processor or multiprocessing or multitasking or parallel processing, etc.

The instructions may be stored in local memories, although it is possible to store the instructions on a remote system and to access the latter via a network.

In the context of embodiments of the invention, “computer-aided” may for example be understood as an implementation of the method in which, in particular, a processor performs at least one method step of the method.

The term “processor”, “central signal processing”, “control unit” or “data evaluation means”, as used here, includes processing means in the broadest sense, that is to say for example servers, universal processors, graphics processors, digital signal processors, application-specific integrated circuits (ASICs), programmable logic circuits such as FPGAs, discrete analog or digital circuits and arbitrary combinations thereof, including all other processing means known to a person skilled in the art or developed in the future. Processors may in this case consist of one or more devices or instruments or units. If a processor consists of a plurality of devices, these may be designed or configured for the parallel or sequential processing or execution of instructions. In the context of embodiments of the invention, a “storage unit” may for example be understood as a memory in the form of a working memory (random-access memory, RAM) or a hard drive.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

### REFERENCES

1. PCT/EP2018/074999
2. The SCIP Optimization Suite 5.0; Ambros Gleixner, Leon Eifler, Tristan Gally, Gerald Gamrath, Patrick Gemander, Robert Lion Gottwald, Gregor Hendel, Christopher Hojny, Thorsten Koch, Matthias Miltenberger, Benjamin Müller, Marc E. Pfetsch, Christian Puchert, Daniel Rehfeldt, Franziska Schlösser, Felipe Serrano, Yuji Shinano, Jan Merlin Viernickel, Stefan Vigerske, Dieter Weninger, Jonas T. Witt, Jakob Witzig, ZIB-Report 17-61, Zuse Institute Berlin, December 2017; http://scip.zib.de.
3. IBM ILOG CPLEX MIP Optimizer; https://www.ibm.com.
4. Andreas Hirsch; Werkzeugmaschinen: Grundlagen, Auslegung, Ausführungsbeispiele [Machine tools: basics, design, example applications], 2^{nd} ed., Springer Vieweg|Springer Fachmedien Wiesbaden 2012, p. 2; https://doi.org/10.1007/978-3-8348-2364-9.

1. A method for computer-aided optimization of tool transports for at least one tool magazine having a number of magazine locations, which is used or is usable for a machine tool that is employed for a processing of one or more workpieces with an aid of tools provided by a magazine operating apparatus at a provision location, the method comprising:
a) recording a set of tools;
b) recording a location requirement for each tool;
c) recording a set of occupiable magazine locations for each tool, at least one subset thereof comprising allowed magazine locations which are dependent on the respective location requirement of the tools, of the tools respectively neighboring one another;
d) recording a set of movement time durations which respectively comprises a trip of the magazine operating apparatus from one magazine location to another magazine location or from a magazine location to the provision location or from the provision location to a magazine location;
e) recording an allowed initial magazine occupancy, an initial magazine location for each tool being recorded;
f) recording a set of tool transports from one magazine position to another allowed magazine position, a tool transport from the set of tool transports requiring a movement time duratior;
g) determining a set of at least one available time interval, in which the movement time duration of one or more tool transports is respectively equal at most to the processing time duration in which the tool provided at the provision location is used for the processing of a workpiece,
h) allocating at least one tool transport from the set off) to a time interval from the set of g) under a condition that the movement time duration for the tool transport is less than or equal to a length of the time interval; and
i) carrying out the at least one tool transport while the machine tool for the processing of the workpiece is in operation in a ready state or in a processing state, as soon as the machine tool reaches an operating state which has been assigned or is assigned to one of the time intervals determined in g) and allocated in h).

2. The method as claimed in claim 1, wherein a partial order of the set of tool transports is specified such that a tool transport that has not yet been performed may be performed when all tool transports previously arranged in the partial order have been performed.

3. The method as claimed in claim 2, wherein the partial order influences the allocation of at least one tool transport to a time interval.

4. The method as claimed in claim 2, wherein the chronological succession of the allocated time intervals is consistent with the partial order of the tool transport.

5. The method as claimed in claim 1, wherein the allocation from h) of claim 1 is carried out by mixed integer linear optimization.

6. The method as claimed in claim 1, wherein a movement time duration includes both a transport time duration, which comprises a trip of the magazine operating apparatus with a tool, and an empty trip time duration, which comprises a trip of the magazine operating apparatus without a tool.

7. The method as claimed in the claim 1, wherein the transport time duration additionally depends on properties of the tool to be transported.

8. The method as claimed in claim 1, wherein the tool transports are taken into account with increasing weighting in the increasing time profile when carrying out the at least one tool transport, presupposing that the tool to be transported is no longer needed for the processing of a workpiece.

9. The method as claimed in claim 1, wherein the tool transports are taken into account with increasing weighting in the increasing time profile when carrying out the at least one tool transport, presupposing that a cumulative waiting time for the magazine operating apparatus in the increasing time profile decreases by a newly allocated magazine location of the tool after the tool transport.

10. The method as claimed in claim 1, wherein the time intervals in which a plurality of tool transports are possible are subdivided into further time intervals in which, if possible, only one tool transport is carried out.

11. A control instrument for computer-aided optimization of tool transports for at least one tool magazine having a number of magazine locations, which is used or is usable for a machine tool that is employed for the processing of one or more workpieces with the aid of the tools provided by a magazine operating apparatus at a provision location, having at least one processing unit which is configured to perform the following steps:
a) recording a set of tools;
b) recording a location requirement for each tool;
c) recording a set of occupiable magazine locations for each tool, at least one subset thereof comprising allowed magazine locations which are dependent on the respective location requirement of the tools, of the tools respectively neighboring one another,
d) recording a set of movement time durations which respectively comprises a trip of the magazine operating apparatus from one magazine location to another magazine location or from a magazine location to the provision location or from the provision location to a magazine
e) recording an allowed initial magazine occupancy, an initial magazine location for each tool being recorded;
f) recording a set of tool transports from one magazine position to another allowed magazine position, a tool transport from the set requiring a movement time duration;
g) determining a set of at least one available time interval, in which the movement time duration of one or more tool transports is respectively equal at most to the processing time duration in which the tool provided at the provision location is used for the processing of a workpiece;
h) allocating at least one tool transport from the set of f) to a time interval from the set of g) under the condition that the movement time duration for the tool transport is less than or equal to the time interval; and
i) carrying out the at least one tool transport while the machine tool for the processing of a workpiece is in operation in a ready state or in a processing state, as soon as the machine tool reaches an operating state which has been assigned or is assigned to one of the time intervals determined in g) and allocated in h).

12. A computer program product, comprising a computer readable hardware storage device having computer readable program code stored therein, said program code executable by a processor of a computer system to implement a method as claimed in claim 1 when it runs on a control instrument or is stored on a computer-readable medium.
